(19) United States
(12) Patent Application Publication
(10) Pub. No.: US 2019/0355164 A1
(43) Pub. Date: Nov. 21, 2019

(54) ITEM AUTHENTICATION USING COMPOSITE LABEL

(71) Applicant: Hang LI, Dallas, TX (US)

(72) Inventor: Hang LI, Dallas, TX (US)

(21) Appl. No.: 16/463,350

(22) PCT Filed: Dec. 12, 2017
(86) PCT No.: PCT/US17/65859

§ 371 Date: May 22, 2019

Related U.S. Application Data
(60) Provisional application No. 62/436,031, filed on Dec. 19, 2016.

(51) Int. Cl. G06T 15/04; B42D 25/324; B42D 25/36; G07D 7/181; G07D 7/2033; G06K 9/00

(52) U.S. Cl. CPC G06T 15/04; B42D 25/324; B42D 25/36; G06K 2009/0059; G07D 7/2033; G06K 9/00577; G07D 7/181

(57) ABSTRACT

Processes and systems described herein enable item authentication using a composite label. In some embodiments, a computing device may receive an authentication request for an item to which a composite label is attached. The computing device may further identify an image corresponding to the label material piece associated with the composite label and provide the image to a mobile device of a user such that the item is authenticated at least based on a 3-dimensional texture of the label material piece.

### CROSS REFERENCE TO RELATED PATENT APPLICATIONS

This application is a national stage application of international application PCT/US2017/065859, filed Dec. 12, 2017, titled “Item Authentication Using Composite Label,” which claims priority to U.S. Provisional Patent Application No. 62/436,031, filed on Dec. 19, 2016, which is hereby incorporated by reference in its entirety.

### BACKGROUND

People authenticate designer products with expertise built throughout years of working experience and focusing on materials as well as implementation details. Authentication based on expertise needs professionals who are difficult to find and may make mistakes. Some approaches use barcode/serial numbers to authenticate a product. However, since the barcode/serial numbers are easily duplicated, such authentication may be compromised with low costs.

### SUMMARY

Described herein are techniques and systems for item authentication using a composite label. In some embodiments, a computing device may receive an authentication request for an item to which a composite label is attached. The computing device may further identify an image corresponding to the label material piece associated with the composite label and provide the image to a mobile device of a user such that the item is authenticated at least based on a 3-dimensional texture of the label material piece.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described concerning the accompanying figures. In the figures, the left-most digit(s) of a reference number identifies the figure in which the reference number first appears. The same reference numbers in different figures indicate similar or identical items.

FIG. 1 is a diagram of an illustrative environment that enables item authentication using a composite label.

FIG. 2 includes photographs of examples of label material pieces associated with composite labels.

FIG. 3 is a schematic diagram of an illustrative computing architecture to enable item authentication using a composite label.

FIG. 4 is a flow diagram of an illustrative process for authenticating items using a composite label.

FIG. 5 is another flow diagram of an illustrative process for authenticating items using a composite label.

FIG. 6 includes additional photographs of examples of label material pieces associated with composite labels.

FIG. 7 includes yet other photographs of examples of label material pieces associated with composite labels.

FIG. 8 includes a photograph of an example of the label material piece 116 shown in FIG. 1 or 204 shown in FIG. 2.

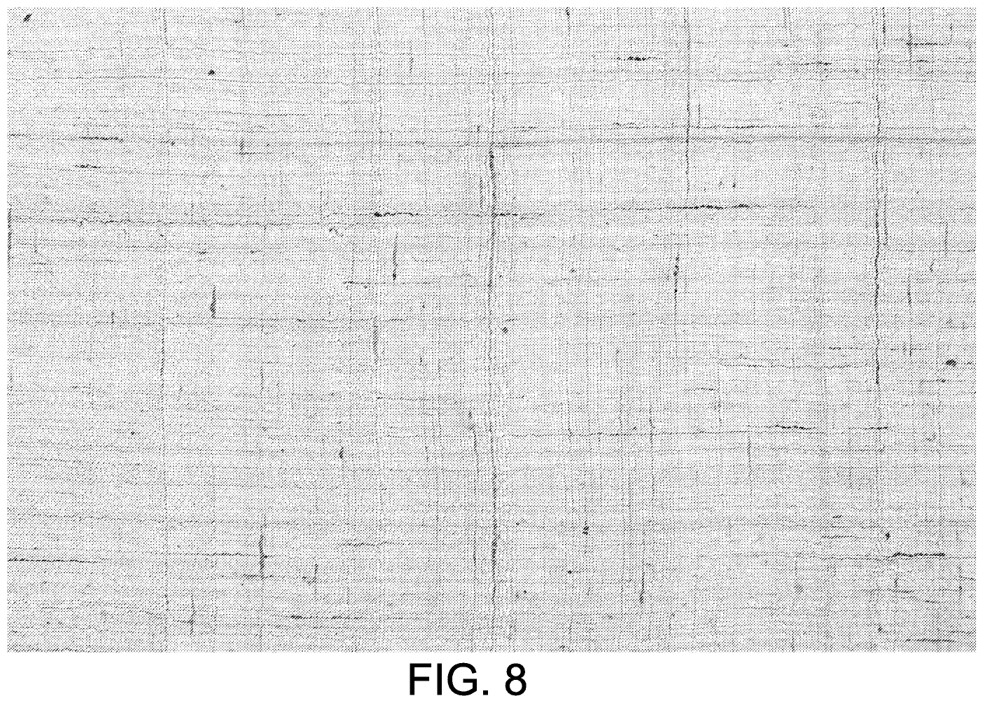

### DETAILED DESCRIPTION

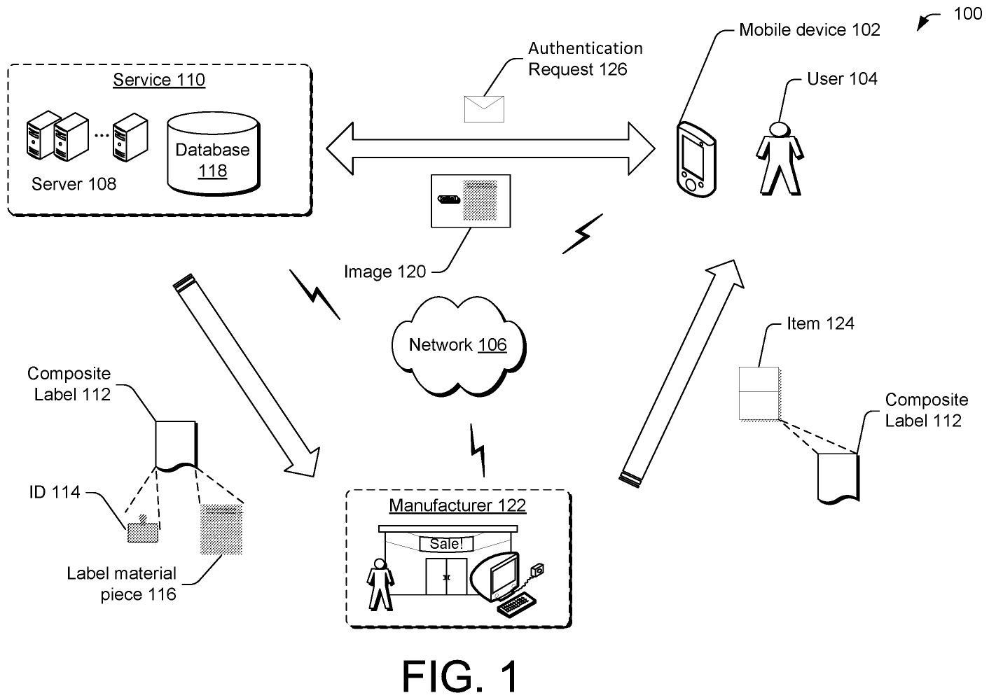

FIG. 1 is a diagram of an illustrative environment 100 that enables item authentication using a composite label. Environment 100 includes a mobile device 102 associated with a user 104. The articles “a” and “an” are used herein to refer to one or more than one (i.e., to at least one) of the grammatical object of the article. By way of example, “a user” means one user or more than one users. User 104 may include a user who uses a computing device (e.g., mobile device 102) to exchange information via a network 106 with other computing devices.

Mobile device 102 may correspond to a wide variety of devices or components that are capable of initiating, receiving or facilitating communications over network 106. Mobile device 102 may include one or more of personal computing devices, electronic book readers (e.g., e-book readers), handheld computing devices, integrated components for inclusion in computing devices, home electronics, appliances, vehicles, machinery, landline telephones, network-based telephones (e.g., voice over IP (“VoIP”), cordless telephones, cellular telephones, smartphones, modems, personal digital assistants, laptop computers, gaming devices, media devices, etc.

Network 106 may include wired and/or wireless networks that enable communications between the various computing devices described in environment 100. In some embodiments, network 106 may include local area networks (LANs), wide area networks (WAN), mobile telephone networks (MTNs), and other types of networks, possibly used in conjunction with one another, to facilitate communication between the various computing devices (e.g., mobile device 102 and a server 108).

Server 108 may be implemented by a service 110. In some embodiments, service 110 refers to a set of related software functionalities that may be reused for different purposes, together with the policies that, for example, authenticating an item. In some instances, service 110 may enable user 104 to determine the likelihood that a given item (any product) being offered for sale by a seller is not a counterfeit item. In certain embodiments, the item includes luxury goods such as designer clothing and clothing accessories.

In some embodiments, service 110 may perform an authentication process to determine the likelihood that a given item is not a counterfeit item and return, to mobile device 102, a result of the authentication process. The result may include a degree of certainty about the authenticity of the given item such as “authentic,” “not authentic,” or in some cases “uncertain.”

In some embodiments, service 110 may enable item authentication using a composite label 112. Composite label 112 may be a tag used to authenticate an item to which composite label 112 is attached. Composite label 112 may be generated using a label material capable of enduring repeated washings. The label material may include an irregular 3-dimensional texture or any material that is difficult to be copied economically. For example, the label material may be a piece of leather or fabric that has irregular and/or unique 3-dimensional texture. The texture may include various features to increase difference and randomness among different label materials. For example, lines with different colors may be used for fabrics.

In some embodiments, the label material may be provided for generating composite label 112. The label material may include a 3-dimensional texture. In certain embodiments, the label material may include a leather material, and the 3-dimensional texture may include an irregular texture of leather textures of the leather material. In certain embodiments, the label material may include a woven fabric, and the 3-dimensional texture may include an irregular sewing texture.

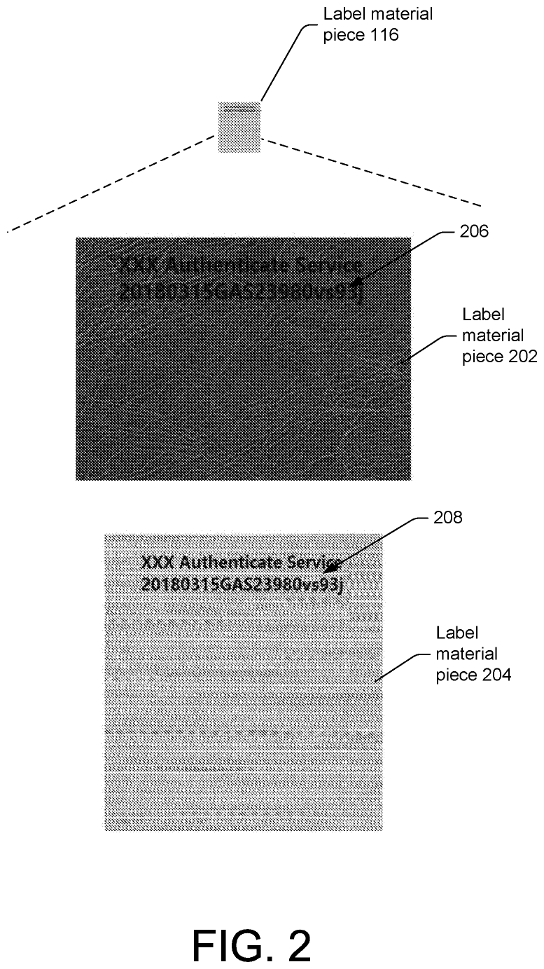

In some embodiments, the label material may be divided into multiple label material pieces each including a portion of the 3-dimensional texture. Examples of the label material pieces are illustrated in FIG. 2, which is described in details below. In some instances, service 110 may assign an identifier (ID) 114 to a label material piece 116 and store ID 114 in a database 118. Database 118 may further include images associated with the label material piece. For example, service 110 may associate ID 114 with an image 120 of label material piece 116, and image 120 may include the portion of the 3-dimensional texture. Service 110 may store the association between ID 114 and image 120 in database 118. In certain embodiments, images stored in database 118 may include an image of the label material, image 120, and/or an image indicating a relative location of label material piece 116 in the label material. These images may enable user 104 to authenticate an item obtained by user 104.

In some embodiments, composite label 112 may be generated using label material piece 116 and ID 114. For example, composite label 112 may include label material piece 116 and a device associated with the ID. The device may include at least one of a sewing label, an iron label, a stick label, a woven label, or a tag label. In certain embodiments, composite label 112 may further include a detectable EAS marker or a detectable RFID marker.

Composite label 112 may be provided to a manufacturer 122, which manufacture an item 124 and provide item 124 to the marketplace. In some embodiments, service 110 may be associated with manufacture 122. For example, manufacturer 122 may provide service 110, or a service provider may provide service 110 to manufacturer 122.

In some embodiments, composite label 112 may be attached to an item 124 such that item 124 is authenticated based on ID 114 and label material piece 116. For example, item 124 may include a garment, a bag, a shoe, or a garment accessory.

After user 104 obtains item 124, user 104 may desire to authenticate item 124. In some embodiments, mobile device 102 may transmit an authentication request 126 to server 108 via network 106. The authentication request 126 may include ID 114 corresponding to image 120. Server 108 may query database 118 to identify image 120 and provide image 120 to mobile device 102.

In some embodiments, a label maker (e.g., the service 110 or the manufacturer 122) may provide a label material including a 3-dimensional texture and divide the label material into multiple label material pieces. For example, an individual label material piece may include at least one portion of the 3-dimensional texture.

In some embodiments, the label material is capable of enduring repeated washings. For example, the label material may include at least one of leather, woven fabric, wood, plastic, stone, metal, or durable artificial/natural materials suitable for labeling. In some embodiments, the label material may include paper made by artificial/natural materials.

In some embodiments, the label maker may assign multiple IDs to the multiple label material pieces, and an individual label material piece of the multiple label material piece corresponds to an ID of the multiple IDs. Further, the label maker may manufacture a composite label based on the individual label material piece using the ID. In these instances, the composite label may include the individual label material piece and a device (e.g., a tag) associated with the ID.

In some embodiments, the 3-dimensional texture is an irregular 3-dimensional texture such that irregular 3-dimensional textures of the multiple label material pieces are different. For example, the irregular 3-dimensional texture may include one or more irregular curved lines, irregular contours, irregular colors and/or other characteristic features. The irregular 3-dimensional texture may occur naturally or simulate natural appearance of a certain material (e.g., leather, wood, stone, etc.).

In certain embodiments, the label material may include a leather material, and the at least one portion of the 3-dimensional texture may include features of leather textures of the leather material. The features of the leather may include an irregular curved line, irregular contour and/or other characteristic features including flaws (FIG. 2).

In certain embodiments, the label material may include a woven fabric, and the at least one portion of the 3-dimensional texture may include a sewing texture. The sewing texture may include an irregular curved line, irregular contour, irregular figure(s) and/or other characteristic features (FIG. 2).

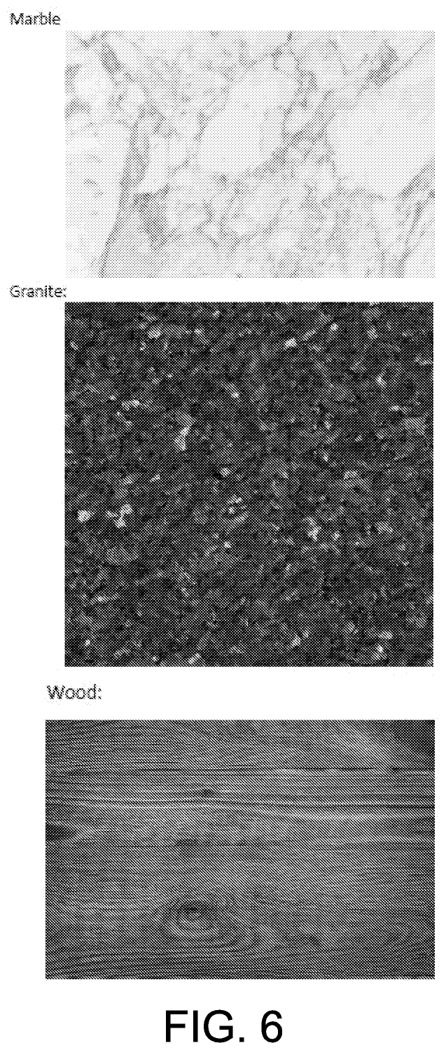

In certain embodiments, the label material may include a piece of polished stone, and the at least one portion of the 3-dimensional texture comprises a natural or artificial appearance texture. The appearance texture may include an irregular curved line, irregular contour, irregular figure(s) and/or other characteristic features (FIG. 6).

In certain embodiments, the label material may include a piece of wood, and the at least one portion of the 3-dimensional texture may include a natural or engineered wood texture. The texture may include an irregular curved line, irregular contour, irregular figure(s) and/or other characteristic features (FIG. 6).

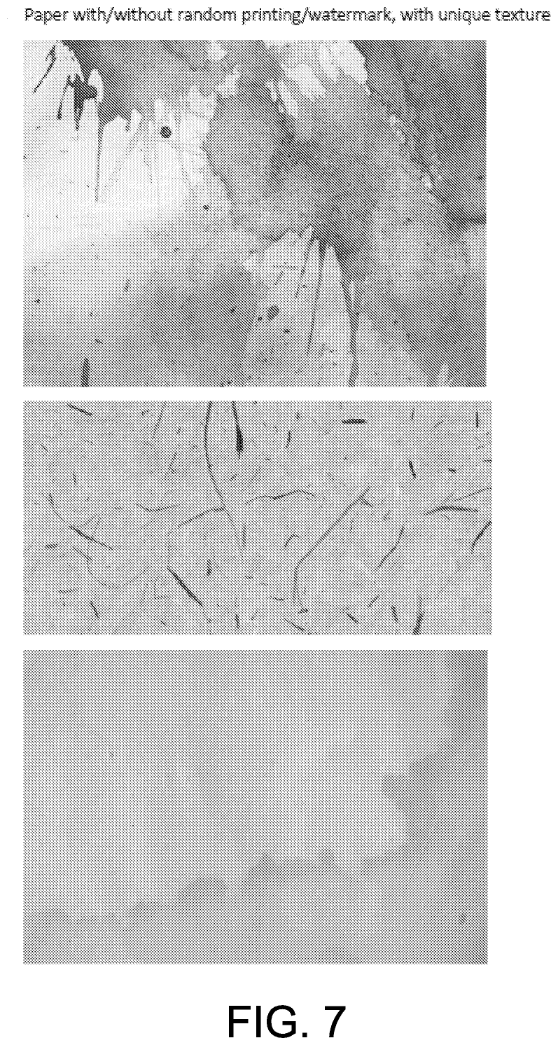

In certain embodiments, the label material comprises a piece of paper, and the at least one portion of the 3-dimensional texture comprises a texture or mark. The texture or mark may include an irregular curved line, irregular contour, colors, irregular figure(s) and/or other characteristic features (FIG. 7).

In some embodiments, the device may include at least one of a sewing label, an iron label, a stick label, a woven label, an ink label, or a tag label.

In some embodiments, the composite label may further include a detectable EAS marker or a detectable RFID marker.

In some embodiments, the label maker may associate the ID with an image or video of the individual label material piece. For example, the image may include the at least one portion of the 3-dimensional texture. Further, the label maker may store the association between the ID and the image or the video in a database; and attach the composite label to an item such that the item is authenticated based on the ID and the individual label material piece. For example, the item may include a garment, a bag, a shoe, or a garment accessory.

FIG. 2 includes photographs illustrating examples 202 and 204 of label material pieces associated with composite labels. In some embodiments, ID 114 may be added to or printed on label material 116 directly (See 206 and 208). As illustrated, the embodiments herein apply uniqueness of the 3-dimensional texture of the label material piece (e.g., fabric or leather) to label the item 124 uniquely. While such label material may be manufactured easily, it is difficult to be duplicated without incurring high costs. Additional examples of label material may be found in FIGS. 6 and 7.

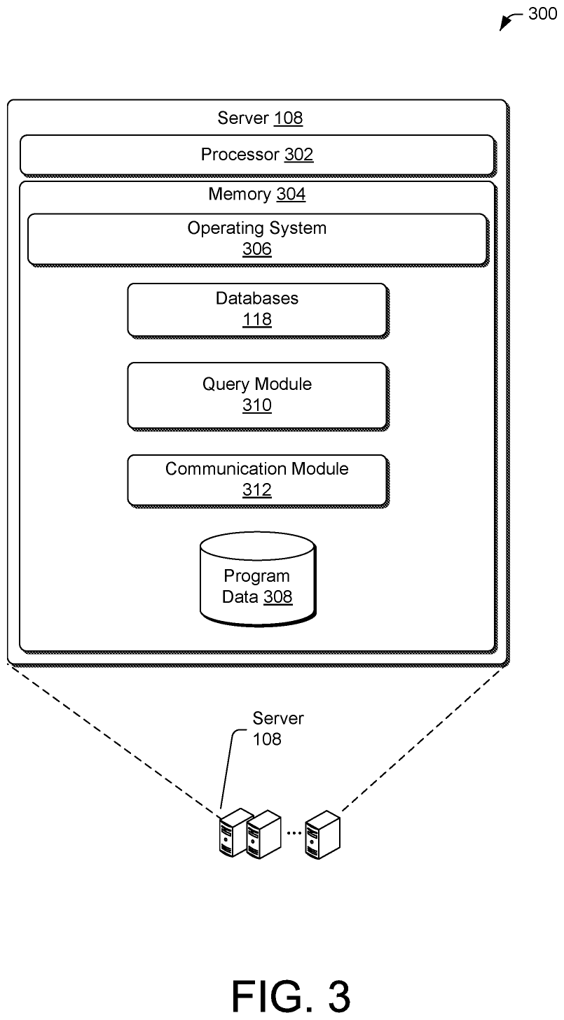

FIG. 3 is a schematic diagram of an illustrative computing architecture 300 configured to enable item authentication using a composite label. Computing architecture 300 shows additional details of at least one portion of service 110, which may include additional modules, kernels, data, and/or hardware.

Computing architecture 300 may include a processor 302 and memory 304. Memory 304 may store various modules, applications, programs, or other data. The memory 304 may include instructions that, when executed by processor 302, cause processor 302 to perform the operations described herein for the server 108. Processor 302 may include one or more graphics processing units (GPU) and one or more central processing units (CPU).

Server 108 may have additional features and/or functionality. For example, server 108 may also include additional data storage devices (removable and/or non-removable). Computer-readable media may include, at least, two types of computer-readable media, namely computer storage media and communication media. Computer storage media may include volatile and non-volatile, removable, and non-removable media implemented in any method or technology for storage of information, such as computer-readable instructions, data structures, program modules, program data, or other data. The system memory, the removable storage, and the non-removable storage are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other medium that can be used to store the desired information and which can be accessed by server 108. Any such computer storage media may be part of server 108. Moreover, the computer-readable media may include computer-executable instructions that, when executed by the processor(s), perform various functions and/or operations described herein.

In contrast, communication media may embody computer-readable instructions, data structures, program modules, or other data in a modulated data signal, such as a carrier wave, or another mechanism. As defined herein, computer storage media does not include communication media.

Memory 304 may store an operating system 306 as well as program data 308, database 118, a query module 310, and a communication module 312. Database 118 may be configured to store associations between multiple IDs and multiple a plurality of images of label material pieces. In some embodiments, an individual ID (e.g., ID 114) corresponding to an individual image (e.g., image 120) of a label material piece (e.g., label material piece 116). In certain embodiments, label material piece 116 may include a 3-dimensional texture.

Query module 310 may be configured to receive, from mobile device 102, authentication request 126 for item 124 to which composite label 112 is attached. Composite label 112 may include ID 114 of the plurality of IDs and label material piece 116 of the label material pieces. Query module 310 may further identify image 120 of multiple images that corresponds to ID 114.

The communication module may be configured to provide image 120 to mobile device 102 such that item 124 is authenticated based on the 3-dimensional texture on the image.

In some embodiments, label material piece 116 is derived from a leather material, and the 3-dimensional texture may include an irregular texture of leather textures of the leather material. For example, the leather textures are natural textures of the leather material. In some embodiments, label material piece 116 is a fabric (e.g., a woven fabric), and the 3-dimensional texture is an irregular sewing texture.

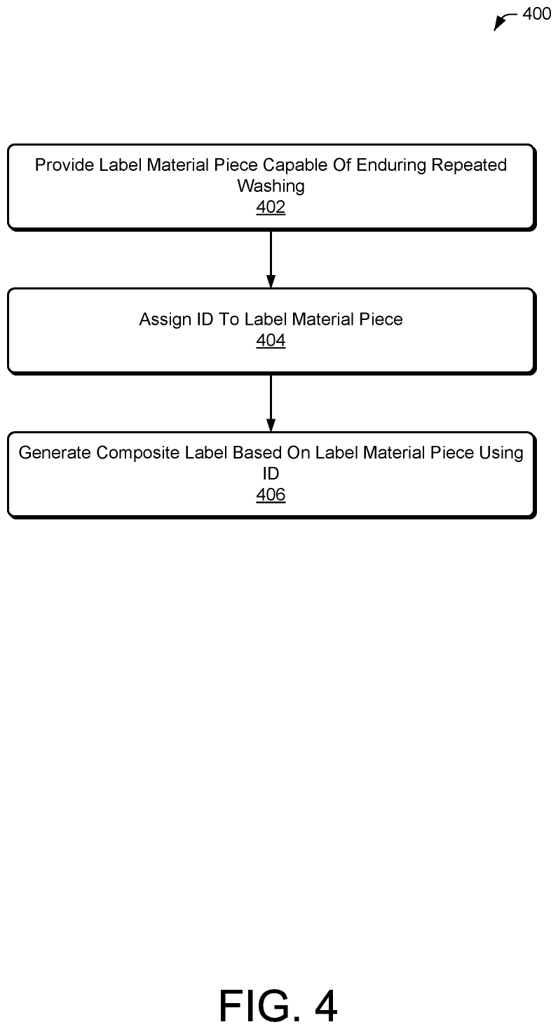

FIG. 4 is a flow diagram of an illustrative process 400 for authenticating items using a composite label. Process 400 is illustrated as a collection of blocks in a logical flow graph, which represents a sequence of operations that can be implemented in hardware, software, or a combination thereof. In the context of software, the blocks represent computer-executable instructions that, when executed by one or more processors, cause the one or more processors to perform the recited operations. Computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 400, shall be interpreted accordingly. Process 400 is described concerning environment 100. However, process 400 may be implemented in other environments, and/or computing architecture.

At 402, a label material piece (e.g., label material piece 116) may be provided and is capable of enduring repeated washings. The label material piece may include at least one portion of an irregular 3-dimensional texture or a random 3-dimensional texture. For example, a label material is provided and is capable of enduring repeated washings. The label material may include the irregular 3-dimensional texture. The label material may be divided into multiple label material pieces.

In some embodiments, label material piece 116 may be a leather material, and the at least one portion of the irregular 3-dimensional texture may include an irregular texture of leather textures of the leather material. In some embodiments, the label material piece may include a woven fabric, and the at least one portion of the irregular 3-dimensional texture may include an irregular sewing texture.

At 404, ID 114 may be assigned to label material piece 116. Server 108 may associate ID 114 with image 120 corresponding to label material piece 116. Image 120 may include the at least one portion of the irregular 3-dimensional texture. Server 108 may store the association between ID 114 and image 120 in database 118. Composite label 112 may be attached to item 124 such that item 124 is authenticated based on ID 114 and label material piece 116. Item 124 may include a garment, a bag, a shoe, or a garment accessory. In some embodiments, the composite label 112 may further include a detectable EAS marker, a detectable RFID marker, QR code, or bar code.

At 406, a composite label (e.g., composite label 112) may be generated based on label material piece 116 using ID 114. For example, composite label 112 may include label material piece 116 and a device associated with ID 114. For example, the device may include at least one of a sewing label, an iron label, a stick label, a woven label, an ink label, or a tag label. In some embodiments, composite label 112 may further include a detectable EAS marker or a detectable RFID marker.

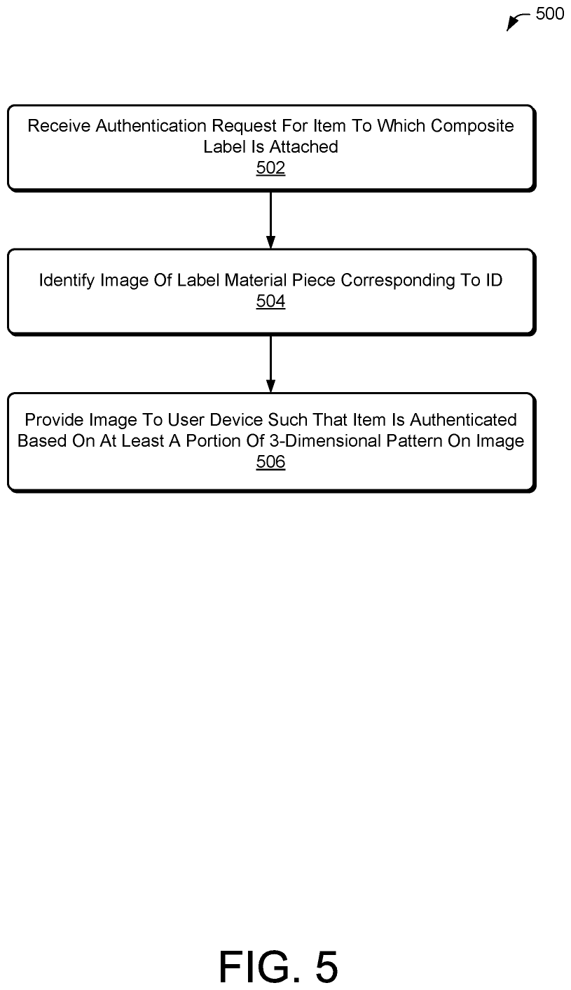

FIG. 5 is another flow diagram of an illustrative process 500 for authenticating items using a composite label. Process 500 is illustrated as a collection of blocks in a logical flow graph, which represents a sequence of operations that can be implemented in hardware, software, or a combination thereof. In the context of software, the blocks represent computer-executable instructions that, when executed by one or more processors, cause the one or more processors to perform the recited operations. Computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 500, shall be interpreted accordingly. Process 500 is described concerning environment 100. However, process 500 may be implemented in other environments, and/or computing architecture.

At 502, server 108 may receive authentication request 126 for item 124 to which composite label 112 is attached. Composite label 112 may include ID 114 and label material piece 116 having at least a portion of a 3-dimensional texture.

At 504, server 108 may identify image 120 corresponding to label material piece 116 that corresponds to the ID. In some embodiments, label material piece 116 may include a leather material, and the at least portion of the 3-dimensional texture may include an irregular texture of leather textures of the leather material. In some embodiments, the label material piece may include a woven fabric, and the at least portion of the 3-dimensional texture may include an irregular sewing texture.

At 506, server 108 may provide image 120 to mobile device 102 such that item 124 is authenticated based on the at least a portion of the 3-dimensional texture on image 120. For example, the item may include a garment, a bag, a shoe, or a garment accessory.

### CONCLUSION

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

What is claimed is:

1. A method of manufacturing a plurality of composite labels, the method comprising:
providing a label material comprising a 3-dimensional texture;
dividing the label material into a plurality of label material pieces, an individual label material piece comprising at least one portion of the 3-dimensional texture;
assigning a plurality of identifiers (IDs) to the plurality of label material pieces, an individual label material piece of the plurality of label material piece corresponding to an ID of the plurality of IDs; and
manufacturing a composite label based on the individual label material piece using the ID, the composite label comprising the individual label material piece and a device associated with the ID.

2. The method of claim 1, wherein the label material piece is capable of enduring repeated washings.

3. The method of claim 1, wherein the 3-dimensional texture is an irregular 3-dimensional texture such that irregular 3-dimensional textures of the plurality of label material pieces are different.

4. The method of claim 3, wherein the label material comprises a leather material, and the at least one portion of the 3-dimensional texture comprises a feature of leather textures of the leather material.

5. The method of claim 3, wherein the label material comprises a woven fabric, and the at least one portion of the 3-dimensional texture comprises a sewing texture.

6. The method of claim 3, wherein the label material comprises a piece of polished stone, and the at least one portion of the 3-dimensional texture comprises a natural or artificial appearance texture.

7. The method of claim 3, wherein the label material comprises a piece of wood, and the at least one portion of the 3-dimensional texture comprises a natural or engineered wood texture.

8. The method of claim 3, wherein the label material comprises a piece of paper, and the at least one portion of the 3-dimensional texture comprises a texture or marks.

9. The method of claim 1, wherein the device comprises at least one of a sewing label, an iron label, a stick label, a woven label, an ink label, or a tag label.

10. The method of claim 1, wherein the composite label further comprises a detectable EAS marker or a detectable RFID marker.

11. The method of claim 1, further comprising:
associating the ID with an image of the individual label material piece, the image comprising the at least one portion of the 3-dimensional texture;
storing the association between the ID and the image in a database; and
attaching the composite label to an item such that the item is authenticated based on the ID and the individual label material piece.

12. The method of claim 11, wherein the item comprises a garment, a bag, a shoe, or a garment accessory.

13. A method of authenticating an item, the method comprising:
receiving, by one or more processors of a computing device from a user device, an authentication request for the item to which a composite label is attached, the composite label comprising an identifier (ID) and a label material piece comprising at least a portion of a 3-dimensional texture;
identifying, by the one or more processors, an image of a label material piece corresponding to the ID; and
providing, by the one or more processors, the image to the user device such that the item is authenticated based on the at least a portion of the 3-dimensional texture on the image.

14. The method of claim 13, wherein the label material piece comprises a leather material, and the at least portion of the 3-dimensional texture comprises an irregular texture of leather textures of the leather material.

15. The method of claim 13, wherein the label material piece comprises a woven fabric, and the at least portion of the 3-dimensional texture comprises an irregular sewing texture.

16. The method of claim 13, wherein the item comprises a garment, a bag, a shoe, or a garment accessory.

17. The method of claim 13, further comprising:
providing a label material capable of enduring repeated washings, the label material comprising the 3-dimensional texture;
dividing the label material into a plurality of label material pieces each comprising of the 3-dimensional texture;
assigning the ID to the label material piece; and
generating the composite label based on the label material piece using the ID, the composite label comprising the label material piece and a device associated with the ID.

18. The method of claim 17, wherein the device comprises at least one of a sewing label, an iron label, a stick label, a woven label, or a tag label.

19. The method of claim 18, wherein the composite label further comprises a detectable EAS marker or a detectable RFID marker.

20. A system for authenticating an item, the system comprising:
one or more processors; and
memory to maintain a plurality of components executable by the one or more processors, the plurality of components comprising:
a database configured to store associations between a plurality of identifiers (IDs) and a plurality of images of label material pieces, an individual ID corresponding to an individual image of a label material piece, the label material piece comprising a 3-dimensional texture,
a query module configured to:
receive, from a user device, an authentication request for the item to which a composite label is attached, the composite label comprising an ID of the plurality of IDs and a label material piece of the label material pieces, and
identify an image of the plurality of images that corresponds to the ID, and
a communication module configured to provide the image to the user device such that the item is authenticated based on the 3-dimensional texture on the image.

21. The system of claim 20, wherein the label material piece comprises a leather material, and the 3-dimensional texture comprises an irregular texture of leather textures of the leather material.

22. The system of claim 20, wherein the label material piece comprises a woven fabric, and the 3-dimensional texture comprises an irregular sewing texture.

23. The system of claim 20, wherein the item comprises a garment, a bag, a shoe, or a garment accessory.

24. The system of claim 20, wherein an individual label material piece of the label material pieces comprises a different 3-dimensional texture from the rest of the label material pieces.

25. The system of claim 20, wherein the label material piece comprises a woven fabric comprising a multiple-color random sewing texture.
